(19) United States
(12) Patent Application Publication
(10) Pub. No.: US 2007/0226394 A1
(43) Pub. Date: Sep. 27, 2007

(54) ALTERNATE STORAGE OF REPEATED DATA WITHIN A DATA STORAGE DEVICE

(75) Inventor: Gayle L. Noble, Boulder Creek, CA (US)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(73) Assignee: FINISAR CORPORATION, Sunnyvale, CA (US)

(21) Appl. No.: 11/692,072

(22) Filed: Mar. 27, 2007

Related U.S. Application Data
(60) Provisional application No. 60/786,138, filed on Mar. 27, 2006.

(51) Int. Cl. G06F 3/06

(52) U.S. Cl. 711/4

(57) ABSTRACT

A data storage device having capabilities for alternate storage of repeated data and methods for alternate storage of repeated data within a data storage device. In one example embodiment, a method is disclosed for a data storage device to alternately store data within the data storage device. First, the data storage device identifies a data pattern that is present at a plurality of physical addresses on the data storage device. Next, the data storage device writes the data pattern to a single physical address. Then, the data storage device remaps the logical address of each of the plurality of physical addresses to the single physical address. Finally, the data storage device allocates a new logical address for each of the plurality of physical addresses. In this example method, the identifying, writing, remapping, and allocating are performed by the data storage device without regard to data file boundaries.

### CROSS-REFERENCE TO RELATED APPLICATIONS

This application claims priority to U.S. Provisional Patent Application Ser. No. 60/786,138, filed on Mar. 27, 2006, which is incorporated herein by reference in its entirety.

### BACKGROUND

1. The Field of the Invention

The present invention relates to data storage devices. More specifically, the present invention relates to a data storage device having capabilities for alternate storage of repeated data, and methods for alternate storage of repeated data within a data storage device.

2. Description of Related Technology

Data storage devices are capable of storing large amounts of digital data in a relatively small area. Data storage devices include, but are not limited to, disk storage devices, flash storage devices, and tape storage devices. Digital data is typically organized and stored on a data storage device in logical groupings known as data files. In order to store more data files holding greater amounts of data on data storage devices, compression methods have been developed for compressing data files prior to storing them on a data storage device. These compression methods, which are generally implemented in operating system software or application software residing on a host computer system, are effective in compacting large data files or groups of data files before being written to a data storage device.

However, implementing these compression methods can be costly in terms of time and system resources. Some compression method implementations compress data files in memory on the host computer system and then write the compressed data files to a data storage device. Other compression method implementations read data files from a data storage device into memory on the host computer system, compress the data files in memory on the host computer system, and then write the compressed data files to the data storage device. However, the act of compressing the data files in the memory of a host computer system burdens the memory and processing resources of the host computer system.

Also, compressed data stored in compressed data files, such as zip files, can not be accessed without first decompressing the compressed data files. The required decompression of compressed data files makes accessing data contained within compressed data files a multi-step process that takes more time than accessing the same data contained in an uncompressed data file.

### BRIEF SUMMARY OF SOME EXAMPLE EMBODIMENTS

In general, embodiments of the invention are concerned with a data storage device having capabilities for alternate storage of repeated data, and methods for alternate storage of repeated data within a data storage device. Among other things, the example data storage devices disclosed herein enable data that is repeated within the data storage devices to be consolidated into a single storage location without burdening the memory and processing resources of a host computer system.

In one example embodiment, a method for storing data includes identifying a data pattern that is present at a plurality of physical addresses on a data storage device, writing the data pattern to a single physical address, remapping the logical address of each of the plurality of physical addresses to the single physical address, and allocating a new logical address for each of the plurality of physical addresses. In this example method, the identifying, writing, remapping, and allocating are performed without regard to data file boundaries.

In another example embodiment, a method for retrieving data includes receiving a request for data stored at a plurality of logical addresses on a data storage device, translating the plurality of logical addresses to a single physical address, retrieving, for each of the plurality of logical addresses, data from the single physical address, and transmitting the retrieved data. In this example method, the receiving, translating, retrieving, and transmitting are performed without regard to data file boundaries.

In yet another example embodiment, a method for handling data overwrite requests includes receiving a request to overwrite data at a logical address on a data storage device and determining whether data stored at a physical address corresponding to the logical address is alternately stored data. If the data stored at the corresponding physical address is alternately stored data, the method further includes determining whether an original physical address corresponding to the logical address is free. If the original physical address is free, the method includes remapping the logical address to the original physical address and storing the data specified in the overwrite request at the original physical address. If, however, the original physical address is not free, the method includes marking the logical address as bad and reporting the bad logical address. If the data stored at the corresponding physical address is not alternately stored data, the method instead includes storing the data specified in the overwrite request at the corresponding physical address.

These and other aspects of example embodiments of the present invention will become more fully apparent from the following description and appended claims.

### BRIEF DESCRIPTION OF THE DRAWINGS

To further clarify certain aspects of the present invention, a more particular description of the invention will be rendered by reference to specific embodiments thereof which are disclosed in the appended drawings. It is appreciated that these drawings depict only example embodiments of the invention and are therefore not to be considered limiting of its scope. Aspects of the invention will be described and explained with additional specificity and detail through the use of the accompanying drawings in which:

FIG. 1A discloses an example host computer system and hard disk drive;

FIG. 1B discloses example data storage on a recording media of a hard disk drive with respect to logical block addresses and physical block addresses;

FIG. 2A discloses an example alternately stored data table;

FIG. 2B discloses an example address allocation table;

FIG. 3 discloses an example method for storing data;

FIG. 4 discloses an example method for retrieving data; and

FIG. 5 discloses an example method for handling data overwrite requests.

### DETAILED DESCRIPTION OF SOME EXAMPLE EMBODIMENTS

Example embodiments of the invention are concerned with data storage devices and, more specifically, data storage devices having capabilities for alternate storage of repeated data, and methods for alternate storage of repeated data within data storage devices. Among other things, the example data storage devices and methods disclosed herein enable data that is repeated within the data storage device to be consolidated into a single storage location without burdening the memory and processing resources of a host computer system. The terms “alternate storage” or “alternate data storage” or “alternately stored data” as used herein refer to a process for storing a single copy of a repeated data pattern. The term “host computer system” as used herein refers to any computing device capable of transmitting data to or receiving data from a data storage device.

Aspects of the invention can be implemented in data storage devices. The term “data storage device” as used herein refers to a device that is capable of permanent, non-volatile data storage, that is, the data will remain stored on the device when power to the device is disconnected or interrupted. Data storage devices can store data in a variety of ways, including mechanically, magnetically, or optically. Example data storage devices in which the example data storage, retrieval, and overwrite methods disclosed herein can be implemented include optical and magnetic disk storage devices, flash storage devices, and tape storage devices. However, the invention can be implemented in any other data storage device capable of identifying repeated data patterns.

Data storage devices have a finite data storage capacity. When a data storage device is full, the data storage device can not store additional data until some of the storage capacity of the data storage device is made available. Embodiments of the present invention seek to make more efficient use of the existing storage capacity of a data storage device by implementing methods that consolidate repeated data patterns into a single storage location on the data storage device.

The example methods disclosed herein may be implemented as part of a computer program-product for use with data storage devices. The program-product defining the functions of this embodiment can be provided to a data storage device as: information permanently stored on read-only storage media; alterable information stored on a writable storage media; or, information conveyed to a data storage device through a computer network or a wireless computer network. It is also noted that portions of the program-product may be developed and implemented independently, but when combined together constitute example embodiments of the invention.

### I. EXAMPLE HARD DISK DRIVE

The example methods disclosed herein can be implemented in software, hardware, firmware or a combination of software, hardware, and/or firmware in a data storage device. One type of data storage device in connection with which the example methods disclosed herein can be implemented is a disk storage device known as hard disk drive. A hard disk drive is a non-volatile data storage device that stores data on magnetic surfaces that are layered onto hard disk platters. The example methods disclosed herein can be implemented in firmware accessible to a hard disk controller that may or may not be included as part of a hard disk drive. A hard disk controller is typically a low powered, inexpensive processor that processes firmware in order to control the read, write, defect management, and error recovery functions of a hard disk drive.

The storage media of a hard disk drive is typically divided into discrete physical portions, sometimes referred to as blocks. Each physical block is permanently identified within the hard disk drive by a physical block address (PBA). Each PBA within a hard disk drive can also be associated with one or more logical block addresses (LBAs). Each LBA within a hard disk drive corresponds to a single PBA within the hard disk drive, although, according to some example embodiments of the methods disclosed herein, more than one LBA can correspond to a single PBA within the hard disk drive.

There are several different ways that an LBA can be organized within a hard disk drive. For example, an LBA can consist of a number from 0 to x−1, where x represents the number of physical blocks in the hard disk drive that can be used to store data. For example, where a hard disk drive has 1024 physical blocks available for data storage, the LBAs for the hard disk drive can range from LBA 0 to LBA 1023.

When data files are sent to the hard disk drive, by a host computer system for example, the hard disk drive is typically directed to store the data in one or more LBAs of the hard disk drive. The hard disk drive then typically translates each LBA of the hard disk drive into a PBA of the hard disk drive. This translation from LBAs to PBAs allows the host computer system to keep track of blocks of data stored in the hard disk drive without keeping track of the exact physical location of each block of data stored in the hard disk drive. This translation from LBAs to PBAs also allows a hard disk drive to re-assign one or more LBAs in the event that a particular PBA becomes unavailable for data storage.

The translation from LBAs to PBAs in a hard disk drive is typically handled by a hard disk controller of the hard disk drive. The translation from LBAs to PBAs is necessary to allow the hard disk drive to implement a defect management scheme and to set aside reserved areas on the recording media of the hard disk drive for manufacturer specific data, disk drive operating firmware, and other data or reserved zones not generally accessible to the operating system of a host computer system.

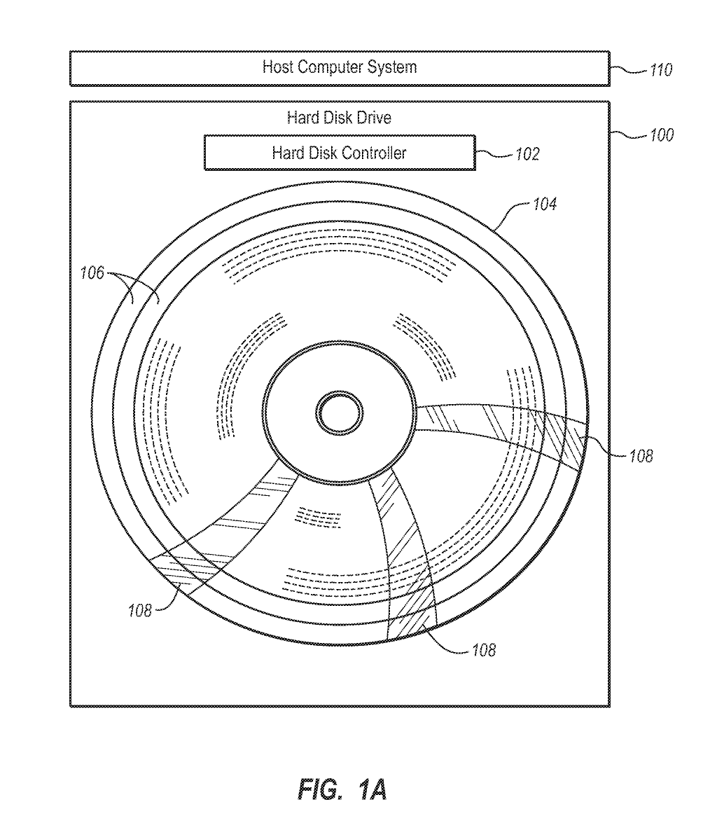

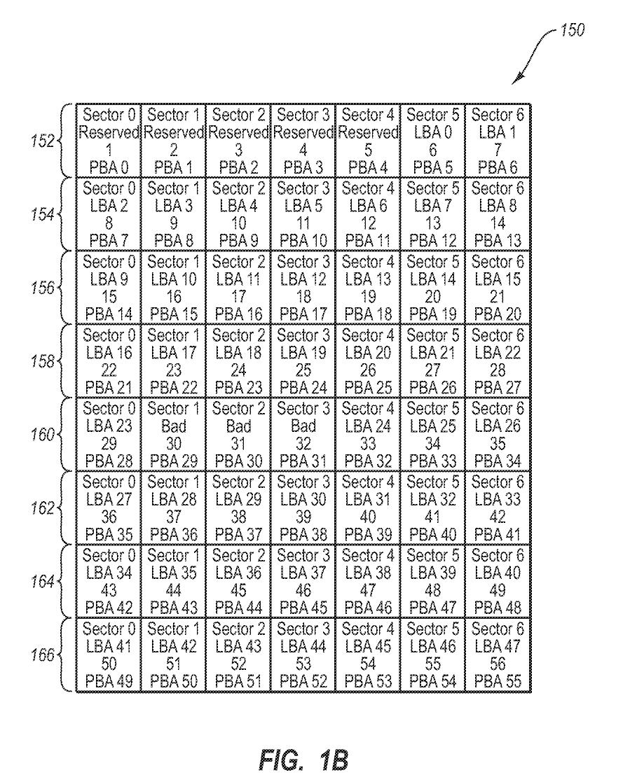

FIG. 1A discloses an example hard disk drive 100 in connection with which some example embodiments of the invention are implemented. Hard disk drive 100 receives commands from host computer system 110 to store or retrieve data. Hard disk drive 100 includes a hard disk controller 102. Hard disk drive 100 also includes recording media 104. Recording media 104 comprises multiple hard disk platters. Hard disk drive 100 will also typically include several other components not explicitly illustrated in FIG. 1A, including one or more of the following: an interface controller adapted to receive external signals and data; memory; a read channel; a preamp; a motor controller; a spindle motor; a voice coil motor; and a read/write head that is moved above the recording media 104 to read and write data to the recording media 104.

Some example embodiments of recording media 104 of hard disk drive 100 comprise multiple hard disk platters coated with a recording material such as ferrous iron, magneto-optical media, and other materials adapted to hold a magnetic charge. Example recording media 104 represents eight recording surfaces upon which data can be stored, although only one of the eight recording surfaces is explicitly illustrated in FIG. 1A.

Recording media 104 includes data storage tracks 106 and a plurality of servo wedges 108. For clarity, only two of the tracks 106 are shown, although recording media 104 includes many more tracks where data can be stored. Data can be stored on a particular track 106 on the recording media 104 in response to commands from hard disk controller 102. The data stored on data tracks 106 can be data sent to hard disk drive 100 from host computer system 110, for example, data organized into data files. Several adjacent tracks 106 can be combined together to create a “zone” of tracks 106 with similar data densities. Servo wedges 108 are portions of each track 106 that may include read/write head(s) alignment indicia, physical address information, and check pointing data used for defect management. Servo wedge data is generally for the use of hard disk drive 100 and is usually inaccessible to host computer system 110. The servo wedges 108 can be used to implement the example methods disclosed herein.

FIG. 1A also discloses host computer system 110 which is in communication with hard disk drive 100. In the example of FIG. 1A, host computer system 110 includes a file system which manages the data files stored on hard disk drive 100.

FIG. 1B discloses example data storage on a recording media of a hard disk drive. Specifically, FIG. 1B represents a cylinder 150 of data stored on recording media 104 of FIG. 1A. A disk drive cylinder is a conceptual division of data on a recording media of a hard disk drive. The concept of a disk drive cylinder is defined by a concentric, hollow, cylindrical slice through one track of the physical recording surfaces of the hard disk drive. Since recording media 104 of FIG. 1A includes eight recording surfaces, cylinder 150 includes eight tracks, denoted generally as tracks 152-166.

Cylinder 150 includes a total of fifty-six physical blocks designed to hold data, denoted generally as blocks 1-56. Each of tracks 152-166 of cylinder 150 includes seven of blocks 1-56. Each groups of seven blocks on each of 152-166 are further denoted as sector zero through sector six. Each sector corresponds to one of blocks 1-56. Data sectors are the fundamental units of data handled by a hard disk controller and usually have a fixed length. For example, many hard disk drives have a fixed data sector length of 512 bytes. Alternatively, data sectors can be of other lengths, or of variable length. In practice, a specific sector is often identified by a specific physical head, cylinder, and sector address. For example, a specific PBA might be “2, 1014, 12” for a particular physical sector on the hard disk drive, where 2 is the 3rd head (heads are labeled 0 through x−1) 1014 is the 1015th cylinder (cylinders are also labeled 0 through x−1) and 12 is the 13th sector (sectors are numbered 0 though x−1).

As disclosed herein, host computer system 110 transmits commands to hard disk drive 100 to store or retrieve data on hard disk drive 100. The data to be either stored or retrieved on hard disk drive 100 is identified by host computer system 110 using LBAs rather than using PBAs. Since tracks 152-166 of recording media 104 include fifty-six PBAs, in some circumstances, tracks 152-166 of recording media 104 would also have fifty-six LBAs, where each of blocks 1-56 would have a PBA with a corresponding LBA. However, due to the defects in portions of recording media 104 on blocks 30-32, which are labeled “Bad” in FIG. 1B, and due to the reservation of blocks 1-5, which are labeled “Reserved” in FIG. 1B, only forty-seven LBAs are available to host computer system 110, denoted as LBA 1-47, even though there are fifty-six PBAs, denoted as PBAs 0-55. The LBA numbers must therefore be adjusted to conform to the available PBAs. This adjustment allows a file with portions located on fragmented PBA blocks to be viewed by host computer system 110 as a continuous file. For example, a file spanning blocks 29-35 can be viewed by host computer system 110 as a continuous file with LBAs 23-26, even though PBAs 29-31 are not used due to the defects in blocks 30-32, and the file is actually fragmented instead of continuous.

### II. EXAMPLE ALTERNATELY STORED DATA AND ADDRESS ALLOCATION TABLES

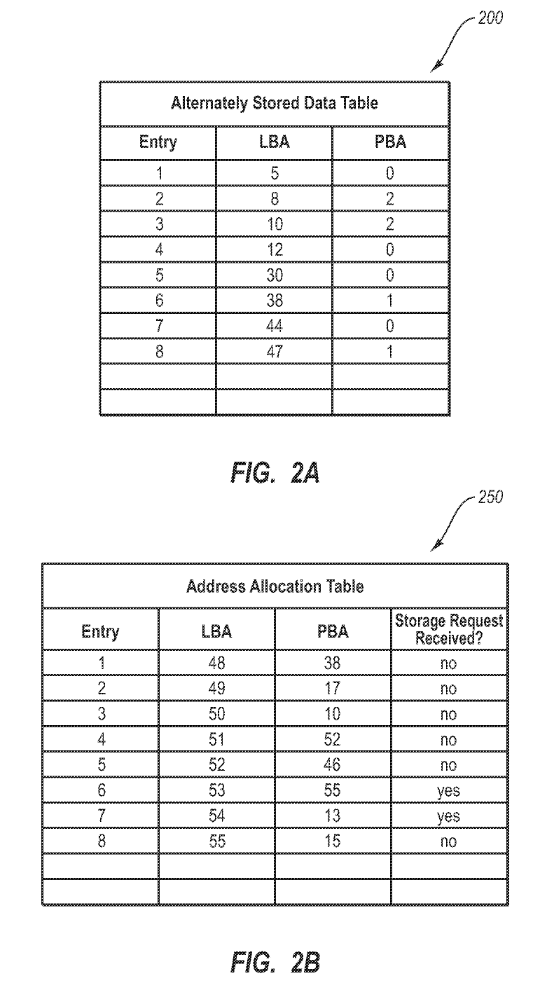

FIGS. 2A and 2B disclose an example alternately stored data table 200 and an example address allocation table 250, respectively. As disclosed in further detail below, alternately stored data table 200 and address allocation table 250 can be used by hard disk controller 102 in conjunction with the data stored on recording media 104 to implement example embodiments of the methods disclosed herein. Alternately stored data table 200 and address allocation table 250 can be implemented as stand alone tables, or can be integrated into existing tables accessible to hard disk controller 102, such as defect management tables or other tables in disk headers or servo wedges 108.

Each entry in alternately stored data table 200 maps an LBA to a PBA. As disclosed in FIG. 2A, multiple LBAs can map to a single PBA in alternately stored data table 200. Additionally, the entries in alternately stored data table 200 can be ordered by LBA in order to allow for efficient location of an entry containing a particular LBA. Each entry in address allocation table 250 maps a newly-allocated LBA to an existing PBA. Each entry in address allocation table 250 is created as a result of the creation of an entry in alternately stored data table 200. For example, entry 1 in address allocation table 250 corresponds to, and was created as a result of the creation of, entry 5 in alternately stored data table 200. In greater detail, when LBA 30 was remapped from the original PBA 38, as disclosed in FIG. 1B, to the alternately stored PBA 0 by the creation of entry 5 in alternately stored data table 200, this remapping made the original PBA 38 free to be reused by another LBA. In order to take advantage of the free PBA 38, a new LBA 48 was allocated, by the creation of entry 1 in address allocation table 250, that maps to the free PBA 38.

### III. EXAMPLE METHOD FOR ALTERNATE STORAGE OF DATA WITHIN A DATA STORAGE DEVICE

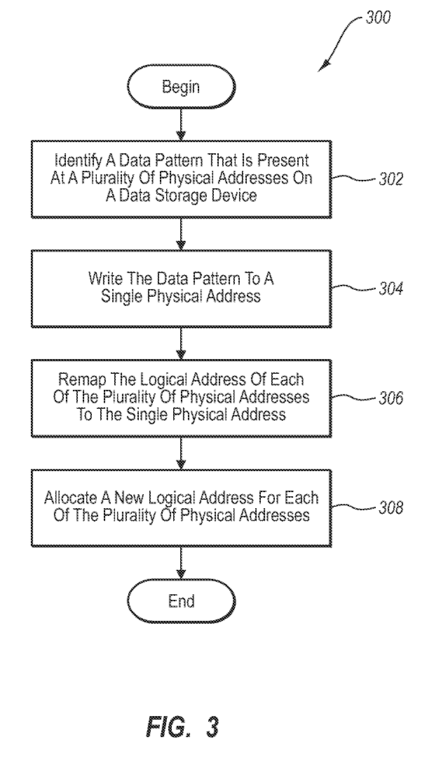

The alternately stored data table 200 and address allocation table 250 can be used in an example method for alternate storage of data within a data storage device. Turning now to FIG. 3, an example method 300 for alternate storage of data is disclosed. In one example embodiment, the performance of the method 300 can be automatically initiated by a data storage device in response to, for example, an idle state in the data storage device, a manual command from a host computer system, or the expiration of a fixed amount of time. It is noted that other events could initiate the performance of the method 300, and the initiation of the performance of the example method 300 is not limited to the occurrence of any particular event.

Method 300 begins at 302 where a data storage device identifies a data pattern present at a plurality of physical addresses on the data storage device. The identification of a repeated data pattern can be accomplished using any of a number of different searching algorithms including, but not limited to, the Lempel-Ziv-Welch algorithm. After the repeated data pattern is identified, the data storage device may also make a determination as to whether size and/or frequency of the repeated data pattern is such as to make space savings worth the time and hard disk drive resources used in method 300. For example, a data storage device may dynamically weigh the benefits and burdens of method 300 for a particular repeated data pattern in order to determine if the benefits outweigh the burdens.

At 304, the data storage device writes the data pattern to a single physical address. The single physical address can be located on a reserved or other portion of the data storage device. Alternatively, the single physical address can be located external to the data storage device, such as on a second data storage device. Writing the repeated data pattern to a single physical address on a second data storage device will protect the repeated data pattern in the event that the first data storage device becomes damaged or otherwise inaccessible. Once the repeated data pattern is written to a single physical address, the physical addresses at which instances of the repeated data pattern were initially identified become free and once again available for data storage, resulting in an increase in available storage space on the data storage device. Alternatively, at 304 the data storage device can identify a single physical address where the repeated data pattern has already been written, for example, in a situation where method 300 had been performed previously within the data storage device.

At 306, the data storage device remaps the logical address of each of the plurality of physical addresses to the single physical address. This remapping can be accomplished in a variety of ways including making one or more entries in an alternately stored data table.

At 308, the data storage device allocates a new logical address for each of the plurality of physical addresses. This allocation can be accomplished in a variety of ways including making one or more entries in an address allocation table. For example, where the highest logical address in the data storage device is 127, and two instances of a repeated data pattern were identified at 302, two new logical addresses of 128 and 129 can be allocated by creating two new entries in the address allocation table.

An example implementation of the example method 300 in a hard disk drive can be considered in further detail with reference to FIGS. 1A, 1B, 2A and 2B. Particularly, method 300 can be initiated by a user of host computer system 110, by an application running on host computer system 110, or by hard disk drive 100 itself Method 300 can also be performed during any medium analysis or other optimization process of the hard disk drive 100, such as a defrag or a surface scan. Thus, the example method 300 can be initiated internally to hard disk drive 100 or externally to hard disk drive 100. The initiation of the example method 300 can occur automatically or in response to user action, as disclosed above. One external application that could initiate method 300 is a SAN manager tool. For example, a SAN manager tool can be running on host computer system 110, and can transmit a command to hard disk drive 100 to perform method 300.

Once method 300 is initiated in hard disk drive 100, at 302, hard disk controller 102 of hard disk drive 100 identifies a data pattern present at a plurality of physical addresses on recording media 104. As disclosed in FIGS. 1A and 1B, hard disk controller 102 can identify a repeated data pattern by searching through tracks 152-166 on recording media 104 for repeated data patterns. Since in this example, tracks 152-166 on recording media 104 have data sectors which hold 512 bytes each, hard disk controller 102 can be configured to search for repeated data patterns that, for example, are 512 bytes long and span entire sectors. It is noted, however, that repeated data patterns having lengths other than 512 bytes and that do not necessarily span entire sectors are also contemplated. As disclosed in the example of FIG. 2A, hard disk controller 102 identifies a repeated data pattern at PBAs 10, 17, 38, and 52, which correspond to original LBAs 5, 12, 30, and 44, respectively, as disclosed in FIG. 1B.

After identifying a data pattern present at a plurality of physical addresses on recording media 104, hard disk controller 102 writes the data pattern to a single physical address at 304. In this case, hard disk controller 102 writes the repeated data pattern to a reserved sector with PBA 0 in track 152 on recording media 104. The repeated data pattern is stored on a reserved (non-user) sector so that the repeated data pattern is not overwritten when any of the files which contain the repeated data pattern are overwritten. As disclosed herein, hard disk controller 102 can alternatively write the repeated data pattern to a PBA that is external to hard disk drive 100 so that the repeated data pattern remains accessible even where the data on hard disk drive 100 becomes inaccessible or corrupted.

Next, at 306, hard disk controller 102 remaps each of the logical addresses of each of the plurality of physical addresses to a single physical address. This remapping is accomplished by making entries 1, 4, 5, and 7 in alternately stored data table 200 disclosed in FIG. 2A. Specifically, entries 1, 4, 5, and 7 in alternately stored data table 200 signify that any requests for the data corresponding to LBAs 5, 12, 30 or 44 should be directed to PBA 0, instead of being directed to the original PBA mappings, PBAs 10, 17, 38 and 52, respectively, as disclosed in FIG. 1B. Thereafter, when any subsequent request is made to hard disk controller 102 for the data corresponding to LBAs 5, 12, 30 or 44, data from the remapped PBA 0 will be returned, instead of data from PBAs 10, 17, 38 or 52, respectively.

Next, at 308, hard disk controller 102 allocates a new LBA for each of the plurality of PBAs 10, 17, 38 and 52 where the repeated data pattern was found. This allocation is accomplished by making entries 1-4 in address allocation table 250 of FIG. 2B. Specifically, a new LBA 48 is created in entry 1 of address allocation table 250 and mapped to PBA 38. Likewise, new LBAs 49, 50 and 51 are created in entries 2-4, respectively, and mapped to PBAs 17, 10, and 52, respectively. These new LBAs are then made available to the host computer system 110 for the storing of data.

After the completion of this example implementation of method 300, hard disk drive 100 can report its number of available sectors as four more than host computer system 110 would have expected because the data from four sectors was consolidated into one sector in the reserved area. In this particular example, since LBA 0 was reserved and therefore not accessible to host computer system 110, the actual increase in sectors available to host computer system 110 for data storage is four sectors, even though the actual savings in space on recording media 104 was three sectors. In this example, hard disk controller 102 handles the translation and mapping between logical sectors and physical sectors without host computer system 110 having any knowledge that alternate data storage that has taken place. Since the resources of host computer system 110 are not used in the example alternate storage method 300, these memory and processing resources are available to host computer system 110 for other applications running on host computer system 110. Thus, example method 300 substantially employs only the resources on hard disk drive 100, and not the resources of host computer system 110.

This example implementation of method 300 illustrates how a repeated data pattern that was identified in four separate locations on recording media 104 of hard disk drive 100 can be alternately stored in a single location. Specifically, this example illustrates how the repeated data pattern originally stored in four separate physical locations can be moved to a single physical location and the four physical locations can then be reallocated for future use to store other data. Alternatively, the repeated data pattern could simply be left in one of the four physical locations and the remaining three physical could then be reallocated for future use to store other data.

Where conventional methods such as data compression are handled by host computer system 100, the memory and processing resources of host computer system 100 are burdened. However, where alternate data storage methods as disclosed herein are handled by hard disk drive 100 without regard to data file boundaries, as disclosed in method 300, the benefits of alternate data storage are realized without burdening the memory and processing resources of host computer system 100.

### IV. EXAMPLE METHOD FOR RETRIEVING DATA WITHIN A DATA STORAGE DEVICE

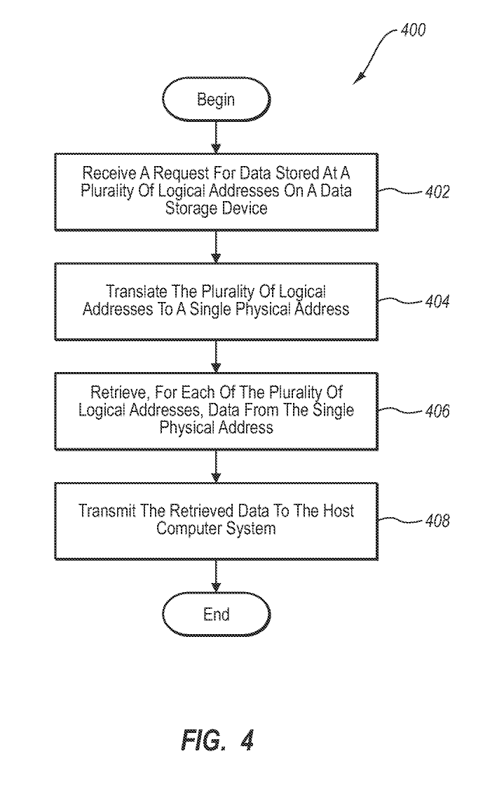

Turning now to FIG. 4, an example method 400 for retrieving data from a data storage device is disclosed. Method 400 begins at 402 where a data storage device receives a request, from a host computer system for example, for data stored at a plurality of logical addresses on the data storage device. At 404, the data storage device translates the plurality of logical addresses to a single physical address. This translation can be accomplished by searching an alternately stored data table for an entry for each of the plurality of logical addresses. At 406, the data storage device retrieves, for each of the plurality of logical addresses, data from the single physical address. At 408, the data storage device transmits the retrieved data, to a host computer system for example.

An example implementation of the example method 400 in a hard disk drive can be considered in further detail with reference to FIGS. 1A, 1B, 2A and 2B. The initiation of method 400 can occur automatically whenever data is requested from hard disk drive 100 by host computer system 110.

At 402, hard disk controller 102 of hard disk drive 100 receives a request from host computer system 110 for the data corresponding to a set of LBAs that make up the data of a data file. For example, the set of LBAs corresponding to the requested data file can be LBAs 9-13. At 404, hard disk controller 102 translates LBAs 9-13 into the current corresponding PBAs. The translation is accomplished by first searching alternately stored data table 200 for an entry for each of the requested LBAs 9-13. Hard disk controller 102 identifies entries 4 and 3, which list LBAs 12 and 10, which are among the LBAs of the requested file. The data for LBAs 12 and 10 is therefore retrieved from PBAs 0 and 2, respectively. Next, since hard disk controller 102 did not find entries for LBAs 9, 11, and 13, hard disk controller 102 will search the mapping disclosed in FIG. 1B in order to determine the PBA which corresponds to each of LBAs 9, 11, and 13. Hard disk controller 102 then determines that LBAs 9, 11, and 13 correspond to PBAs 14, 16 and 18, respectively.

Next, at 406, hard disk controller 102 retrieves the data for LBAs 9, 11, and 13 from PBAs 14, 16 and 18, respectively. At 408, hard disk drive 100 transmits the data retrieved from PBAs 14, 0, 16, 2 and 18 for LBAs 9-13, respectively, to host computer system 110.

This example implementation of method 400 illustrates how two repeated data patterns that had been identified and alternately stored in two separate physical locations on recording media 104 of hard disk drive 100 can be retrieved as part of a normal read operation. Specifically, this example shows how two repeated data patterns that have been moved to reserved PBAs 0 and 2 can be retrieved when the data is requested by host computer system 110.

### V. EXAMPLE METHOD FOR HANDLING OVERWRITE REQUESTS WITHIN A DATA STORAGE DEVICE

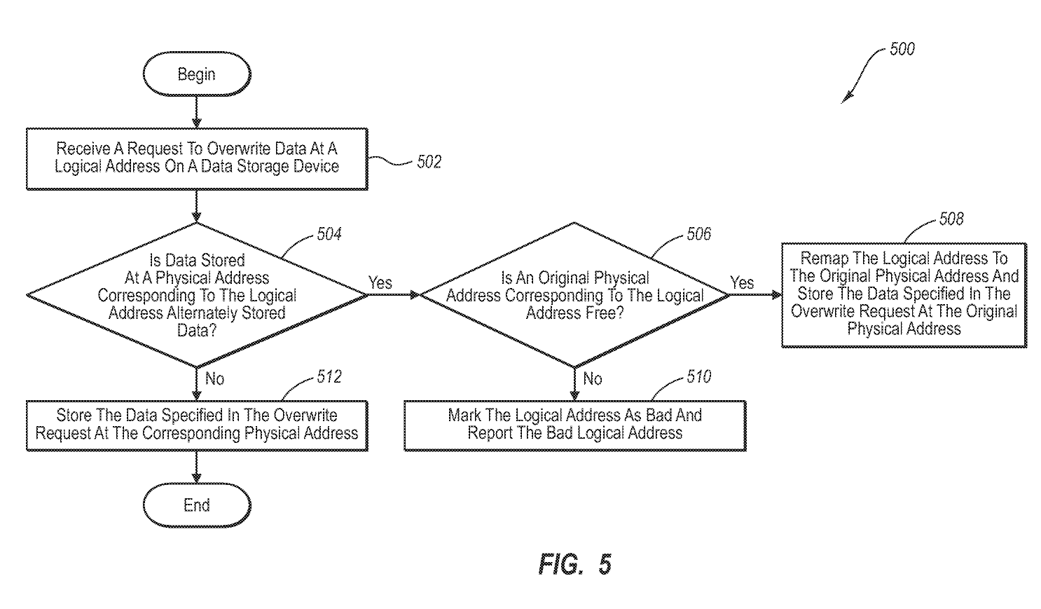

Turning now to FIG. 5, an example method 500 for handling overwrite requests is disclosed. Method 500 begins at 502 where the data storage device receives a request, from a host computer system for example, to overwrite data at a logical address on the data storage device. At 504, the data storage device determines whether the data stored at the physical address corresponding to the logical address is alternately stored data.

If it is determined at 504 that the data stored at the corresponding physical address is alternately stored data, method 500 proceeds to 506 where the data storage device determines if the original physical address corresponding to the logical address is free. If it is determined at 506 that the original physical address is free, method 500 proceeds to 508 where the data storage device remaps the logical address to the original physical address corresponding to the logical address and stores the data specified in the overwrite request at the original physical address. If it is determined at 506 that the original physical address is not free, however, method 500 proceeds to 510 where the data storage device marks the logical address as bad and reports the bad logical address to the host computer system.

Returning to 504, if it is determined at 504 that the data stored at the corresponding physical address is not alternately stored data, method 500 proceeds to 512 where the data storage device stores the data specified in the overwrite request at the corresponding physical address.

An example implementation of the example method 500 in a hard disk drive can be considered in further detail with reference to FIGS. 1A, 1B, 2A and 2B. The initiation of method 500 can in this example occur automatically whenever data is requested to be stored on hard disk drive 100 by host computer system 110 or another system or device. At 502, hard disk controller 102 of hard disk drive 100 receives a request from host computer system 110 to overwrite data at LBA 44. At 504, hard disk controller 102 determines whether the data stored at the PBA corresponding to LBA 44 is alternately stored data. This determination can be made by searching alternately stored data table 200 of FIG. 2A for an entry containing LBA 44. If an entry exists in alternately stored data table 200, hard disk controller 102 will know that LBA 44 has been remapped to a PBA containing alternately stored data. Likewise, if hard disk controller 102 determines that the PBA corresponding to LBA 44 is in a reserved area of hard disk drive 100, then hard disk controller 102 will know that LBA 44 has been remapped to a PBA containing alternately stored data. If an entry does not exist in table 200, however, hard disk controller 102 will know that LBA 44 has been not been remapped to a PBA containing alternately stored data. In this example, hard disk controller finds entry 7 in alternately stored data table 200, and by virtue of the fact that an entry has been found, hard disk controller 102 determines that the data in corresponding PBA 0 is alternately stored data.

Since hard disk controller 102 determined at 504 that the data in PBA 0 is alternately stored data, hard disk controller 102 determines, at 506, whether PBA 52 is free. In this context, free means that the host computer system has not yet requested hard disk drive 100 to store data at LBA 51. Address allocation table 250 can include a flag for each table entry that is set once a storage request is received for each table entry. Whether or not host computer system 110 has requested hard disk drive 100 to store data at LBA 51 can then be determined by checking this flag for table entry 4 in address allocation table 250.

If hard disk controller 102 determines at 506 that the PBA 52 is free, hard disk controller 102 proceeds at 508 to remap the LBA 44 to PBA 52 by simply deleting entry 7 in alternately stored data table 200 and entry 4 in address allocation table 250. This remapping is necessary because LBAs 30, 12, and 5 all correspond to PBA 0, and writing the data requested at 502 at PBA 0 would overwrite the data required by data files corresponding to LBAs 30, 12, and 5.

If hard disk controller 102 determines at 506 that the PBA 52 is not free, however, hard disk controller 102 proceeds at 510 to mark LBA 44 as bad and report the LBA 44 as bad to host computer system 110. Hard disk controller 102 can mark LBA 44 as bad in existing tables accessible to hard disk controller 102, such as defect management tables or other tables in disk headers or servo wedges 108. Reporting LBA 44 as bad to host computer system 110 informs host computer system 110 that LBA 44 can no longer be used to store data. Since hard disk controller 102 reports to host computer system 110 that LBA 44 is bad, host computer system 110 will not attempt to write data to LBA 44, and thus the data at PBA 0 will therefore not be overwritten.

This example implementation of the example method 500 illustrates how hard disk drive 100 can avoid overwriting stored data that may be associated with other LBAs. This example implementation also illustrates how a data storage device can avoid overwriting data at a PBA where the PBA contains alternately stored data.

Occasionally, after a repeated data pattern has been alternately stored at a particular PBA, one or more of the LBAs corresponding to the repeated data pattern will be deleted by host computer system 110, leaving only a single LBA corresponding to the particular PBA. Additionally, where all LBAs corresponding to a particular PBA having an alternately stored repeated data pattern are deleted by the user, the alternate data storage table should be updated to show those that LBAs are no longer mapped to the reserved PBA.

Hard disk drive 100 can also be configured to occasionally shuffle which PBAs correspond to which LBAs on recording media 104. This can enable the reuse of LBAs which are no longer being used by hard disk drive 100. This shuffling can be accomplished by removing an entry from alternately stored data table 200 for each unused PBA listed in address allocation table 250. The entry containing the unused PBA in address allocation table 250 is also removed from address allocation table 250. The LBA of the entry removed from alternately stored data table 200 can then be mapped to the PBA of the entry removed from address allocation table 250. This mapping can occur, for example, in the standard LBA to PBA mapping of hard disk drive 100 as shown in FIG. 1B. The LBA of the entry removed from the address allocation table 250 can then be reused later in address allocation table 250 as a result of the performance of the alternate storage method 300.

### VI. EXAMPLE ALTERNATIVE EMBODIMENTS

The example methods disclosed herein can be implemented using repeated data patterns of variable length that do not conform exactly to fixed-length sector boundaries. For example, a repeated data pattern can span more than one sector, and any given sector can be subdivided in order to determine the exact physical address and number of bytes that correspond to any given logical address. Existing tables in servo wedges of hard disk drives can be used to implement variable-length repeated data pattern alternate storage. Although flash drives do not have servo wedges, they do have defect management tables and logical-to-physical mappings that can be updated in order to implement variable-length repeated data pattern alternate storage. Thus, a data storage device, whether it be a flash drive or a hard disk drive, can alternately store data as disclosed herein even where the size of the repeated data patterns on a data storage device is smaller or larger than the size of the sectors on the data storage device.

The example alternately stored data table and example address allocation table disclosed herein can be implemented in existing defect management tables in existing data storage devices. Defect management tables are used where data blocks are defective. If a data block is, or becomes, defective on a storage medium of a data storage device, the data on that block is written to a spare sector and the data storage device maps all read requests of the logical sector to the physical sector where the data has been moved. Thus, once a data storage device translates the logical block to a physical location, the data storage device can also look at the defect mapping to see if the logical block has “slipped” or has been relocated. Slipped sectors can be written in header information along with head/cylinder/sector information on each data sector. Slipped sectors can also be written to a servo track which can be located at regular intervals around a track. In similar fashion, the physical block address of the reserved sector where alternately stored repeated data has been moved can be stored in a table similar to the defect management table, or in the defect management table itself. The data storage device can then fetch the data from the reserved sector as it would have for a defective sector. The data storage device can have a pool of spare LBAs per zone, and can reassign spare logical block addresses to sectors that have become available due to the detection of a repeated data pattern.

When a drive calculates the physical location of an LBA, the drive must adjust the physical location of the LBA based on defects on the track on which the conversion falls. In particular, the drive looks up the slipped sectors for the track in a defect management table. The table indicates how many sectors have been slipped on the track and if any of the sectors have been moved “off track” because the number of defects on the track has exceeded the capacity of the track. For example, five sectors can be reserved on each track for data to slip into as defects grow. If the drive runs out of spares on a track, the data that falls off the track is moved to the reserved area at the end of the zone used for defect overflow. This defect management table could show that the LBA should then be translated to the physical location of the repeated data that is stored elsewhere on the data storage device.

Another example alternative embodiment of the present invention involves replacing repeated data patterns in a data storage device with location indicators. The term “location indicators” as used herein refers to data stored in place of a repeated data pattern which indicates a location where the repeated data pattern is physically located. For example, instead of using alternately stored data table 200 and address allocation table 250, the data stored in these tables, or equivalent data, could be stored in a location indicator, or in association with a location indicator, that is placed in a data block where repeated data has been alternately stored.

The present invention may be embodied in other specific forms without departing from its spirit or essential characteristics. The disclosed embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for storing data, the method comprising:
identifying a data pattern that is present at a plurality of physical addresses on a data storage device;
writing the data pattern to a single physical address;
remapping the logical address of each of the plurality of physical addresses to the single physical address; and
allocating a new logical address for each of the plurality of physical addresses;
wherein the identifying, writing, remapping, and allocating are performed without regard to data file boundaries.

2. The method as recited in claim 1, wherein identifying a data pattern that is present at a plurality of physical addresses comprises using the Lempel-Ziv-Welch algorithm to identify a data pattern that is present at a plurality of physical addresses.

3. The method as recited in claim 1, wherein writing the data pattern to a single physical address comprises writing the data pattern to a single physical address located on the data storage device.

4. The method as recited in claim 1, wherein writing the data pattern to a single physical address comprises writing the data pattern to a single physical address located on a second data storage device.

5. The method as recited in claim 1, wherein remapping the logical address of each of the plurality of physical addresses to the single physical address comprises making one or more entries in an alternately stored data table.

6. The method as recited in claim 1, wherein allocating a new logical address for each of the plurality of physical addresses comprises making one or more entries in an address allocation table.

7. The method as recited in claim 1, wherein the method is performed in connection with a data storage device that comprises one of a disk storage device, a flash storage device, or a tape storage device.

8. A method for retrieving data, the method comprising:
receiving a request for data stored at a plurality of logical addresses on a data storage device;
translating the plurality of logical addresses to a single physical address;
retrieving, for each of the plurality of logical addresses, data from the single physical address; and
transmitting the retrieved data;
wherein the receiving, translating, retrieving, and transmitting are performed without regard to data file boundaries.

9. The method as recited in claim 8, wherein translating the plurality of logical addresses to a single physical address comprises searching an alternately stored data table for an entry for each of the plurality of logical addresses.

10. The method as recited in claim 8, wherein the single physical address is located on the data storage device.

11. The method as recited in claim 8, wherein the single physical address is located on a second data storage device.

12. A method for handling data overwrite requests, the method comprising:
receiving a request to overwrite data at a logical address on a data storage device;
determining whether data stored at a physical address corresponding to the logical address is alternately stored data;
if the data stored at the corresponding physical address is alternately stored data:
determining whether an original physical address corresponding to the logical address is free;
if the original physical address is free, remapping the logical address to the original physical address and storing the data specified in the overwrite request at the original physical address; or
if the original physical address is not free, marking the logical address as bad and reporting the bad logical address; and
if the data stored at the corresponding physical address is not alternately stored data, storing the data specified in the overwrite request at the corresponding physical address.

13. The method as recited in claim 12, wherein determining whether the data stored at a physical address corresponding to the logical address is alternately stored data comprises searching an alternately stored data table for an entry for the logical address.

14. The method as recited in claim 12, wherein determining whether the original physical address corresponding to the logical address is free comprises checking a flag in a table entry in an address allocation table.

15. The method as recited in claim 12, wherein the corresponding physical address is located on the data storage device.

16. The method as recited in claim 12, wherein the corresponding physical address is located on a second data storage device.

17. The method as recited in claim 12, wherein the request is received from a host computer system.

18. The method as recited in claim 12, wherein remapping the logical address to the original physical address comprises deleting an entry corresponding to the logical address from an alternately stored data table and deleting an entry corresponding to the logical address from an address allocation table.

19. The method as recited in claim 12, wherein marking the logical address as bad comprises marking the logical address as bad in a defect management table.

20. The method as recited in claim 12, wherein the method is performed in connection with a data storage device that comprises one of a disk storage device, a flash storage device, or a tape storage device.
